(19) United States
(12) Patent Application Publication
(10) Pub. No.: US 2006/0273200 A1
(43) Pub. Date: Dec. 7, 2006

(54) Nail polish applicator

(75) Inventors: Shannon Walker Williams, Mequon, WI (US); Casey A. Ketterhagen, Milwaukee, WI (US)

Correspondence Address: RATHE PATENT & IP LAW, 10611 W. HAWTHORNE FARMS LANE, MEQUON, WI, 53097, US

(73) Assignee: Shannon Walker Williams

(21) Appl. No.: 11/429,737

(22) Filed: May 8, 2006

Related U.S. Application Data
(63) Continuation of application No. 10/662,958, filed on Sep. 15, 2003, now abandoned.
(60) Provisional application No. 60/413,528, filed on Sep. 25, 2002.

(51) Int. Cl. F23D 14/28; A01G 25/14; B05B 7/32

(52) U.S. Cl. 239/337; 239/376; 239/378

(57) ABSTRACT

A nail polish applicator includes a propellant container, a nozzle and an actuator. The propellant container extends along a longitudinal axis and contains a nail polish under pressure. The nozzle is coupled to the container and has an outlet. The actuator is configured to selectively dispense the nail polish through the nozzle. The nozzle is configured to dispense the nail polish along a dispensing axis substantially parallel or coextensive with the longitudinal axis of the container.

### CROSS REFERENCE TO RELATED APPLICATIONS

The present application claims priority under 35 U.S.C. § 119(e) from co-pending U.S. Provisional Patent Application Ser. No. 60/413,528 filed by Williams et al. on Sep. 25, 2002 and having the same title as the present application, the full disclosure of which is hereby incorporated by reference.

### FIELD OF THE INVENTION

The present invention relates generally to cosmetic applicators. In particular, the present invention relates to nail polish applicators which apply either a pigment or a translucent coating on a person's fingernails or toenails.

### BACKGROUND OF THE INVENTION

The painting of fingernails and toenails has been a popular activity among both men and women for ages. In its most simple form, dyes or colors containing pigment (paint or polish) are applied in liquid form by a bristle brush to the upper surface of the nail. Generally, the polish is applied to the nail such that the nail is one solid color. In recent years, the painting of nails has gone to the next level with the creation of very detailed and ornate multi-colored designs on the nail. The creation of such ornate and detailed designs has been largely facilitated by the use of air-brush applicators either in professional salons or in do-it-yourself at-home applications.

Professional salons typically use an applicator that is supplied with pressurized air from a compressor. The pressurized air created by the compressor is transmitted to the applicator via a tube connected to the applicator. The polish is supplied to the applicator either by a cup connected to the applicator or by a tube connected at one end to the applicator and at the other end to a separate polish reservoir. The pressurized air created by the compressor combines with the polish to form an aerosol which is applied through a nozzle.

At-home applications are much simpler in nature. At-home applications typically utilize an applicator having a container filled with liquid polish under pressure and a nozzle permanently mounted to the container and extending generally perpendicular to the container. Alternatively, some do-it-yourself at-home kits employ an applicator similar to those used in professional salons, except that the source of pressurized air is a can of propellant which is connected to the applicator via a flexible tube. These kits employ a cup or a vial which is connected to the applicator and which feeds polish to the applicator with the assistance of gravity.

Although the use of air-brush applicators has greatly enhanced the level of detail of designs created on a relatively small fingernail or toenail, as compared to bristle brushes, current air-brush applicators still present an obstacle to creating truly ornate and detailed designs. This obstacle results from the poor ergonomic configuration of existing air-brush applicators. In particular, those applicators requiring a separate source of compressed air (whether from a compressor or a can of propellant) require at least one connecting tube to extend from the applicator. In addition, the applicator must also be provided with either a cup or yet another tube for its supply of polish. Such projections make gripping and manipulating of the applicator difficult. Although this difficulty is usually overcome by professionals who spend hour upon hour developing their skills, this same problem greatly impedes at-home do-it-yourselfers.

These air-brush applicators having an integrated source of compressed air and polish are no better. The container of pressurized paint which hangs from the gripping portion of the applicator is generally bulky and difficult to hold and manipulate. Moreover, because the applicator requires the user to grip the applicator in a similar fashion to that of a gun or a can of bug spray, such applicators are not well suited to the precise manipulation required to create intricate and ornate designs on a nail.

### BRIEF DESCRIPTION OF THE DRAWINGS

FIG. 1 is a perspective view of an example of a nail polish applicator of the present invention with a cap separated from a housing of the applicator.

FIG. 2 is a perspective view of the applicator of FIG. 1 with the cap on the housing.

FIG. 3 is a front elevational view of the applicator of FIG. 1, the rear elevational view being a mirror image thereof.

FIG. 4 is a sectional view of the applicator of FIG. 3.

FIG. 5 is a sectional view schematically illustrating a first example of a container and a valve assembly of the applicator of FIG. 1.

FIG. 6 is a sectional view schematically illustrating a second example of a container and a valve assembly of the applicator of FIG. 1.

FIG. 7 is a perspective view schematically illustrating the applicator of FIG. 1 in greater detail with portions of applicator 30 shown as being transparent with broken lines for purposes of illustration.

FIG. 8 is a sectional view of the applicator of FIG. 7.

FIG. 9 is a perspective view of the housing of the applicator of FIG. 1.

FIG. 10 is a perspective view of a portion of the housing of FIG. 9.

FIG. 11 is a perspective view of an alternative embodiment of the applicator of FIG. 1 illustrating a cap on a housing.

FIG. 12 is a perspective view of the applicator of FIG. 11 illustrating the cap removed from the housing.

### DETAILED DESCRIPTION OF THE EXAMPLE EMBODIMENTS

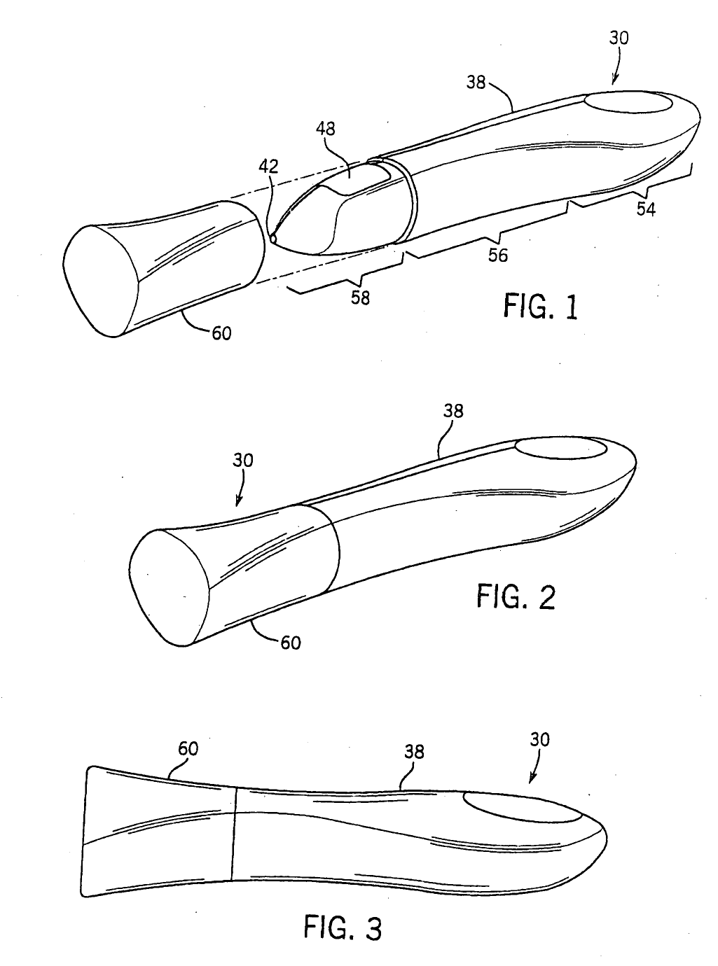

FIGS. 1-8 illustrate nail polish applicator 30. Nail polish applicator 30 is configured to apply a paint, dye, pigment or color (collectively referred to as nail polish) to a fingernail or toenail of a person. Applicator 30 generally includes container 32, nozzle 34, actuator 36 and housing 38. Container 32 generally comprises an elongate container which contains nail polish under pressure with a pressurized gas. Container 32 generally has a size similar to that of a Binaca dispenser. Container 32 is sufficiently pressurized such that the nail polish, when expelled through nozzle 34, is in the form of an aerosol spray. Container 32 includes a stem 40 through which the nail polish is expelled from container 32. Stem 40 is fluidly coupled to an aerosol valve assembly (not shown) housed within or located at a top of container 32. The valve assembly may comprise any one of a variety of valve assemblies such as shown and described in THE PLAIN MAN'S GUIDE TO AEROSOLS found on Sep. 24, 2002 at the website http://www.yorks.karoo.net/aerosol/link6.htm, the full disclosure of which is hereby incorporated by reference. As set forth in “THE PLAIN MAN'S GUIDE TO AEROSOLS,” aerosol valves include a valve housing which supports a spring and an inner gasket. The inner gasket normally closes the valve stem. However, depressment or movement of the valve stem against the biased force of the spring opens the orifice extending through the valve stem to allow the discharge of product (nail polish). Other explanations of aerosol valve assemblies are found in the publication Harris, Tom, “HOW AEROSOL CANS WORK” found on Sep. 24, 2002 at the website http://www.howstuffworks.com/aerosol-can.htm, the full disclosure of which is incorporated by reference. Additional explanations are found in U.S. Pat. No. 2,090,334 issued to Paasche; U.S. Pat. No. 4,239,407 issued to Knight; U.S. Pat. No. 4,139,128 issued to Ewald; and U.S. Pat. No. 1,800,156 issued to Rotheim; the full disclosures of which are hereby incorporated by reference.

Unlike typical valve assemblies-which are designed for use when the container is in a substantially vertical or upright orientation and in which the dip tube extends to the bottom of the container, the valve assembly of the present applicator 30 is configured for enabling applicator 30 to be used in a horizontal or downwardly tilted orientation. FIGS. 5 and 6 schematically illustrate variously configured dip tubes of the valve assembly within container 32. As shown by FIG. 5, in one embodiment, the valve assembly 52 may include a dip tube 54 that is configured to extend along a bottom side of container 32 when container 32 is in a horizontal or a vertically inclined orientation (i.e. when the trigger of actuator 36 is substantially along the top side of container 32). The dip tube includes a plurality of inlets 56 along its length. In this embodiment, the propellant forces the nail polish through the inlets 56 and through the dip tube 54 when the valve assembly 52 is actuated by movement of stem 40. The term “dip tube” is used to encompass a structure through which fluid may be supplied to the valve assembly in the interior of the container.

FIG. 6 illustrates an alternative valve assembly 152 for container 32. In this configuration, the inlet or opening 156 of the dip tube 154 is situated close to stem 40. As a result, when container 32 is downwardly inclined as shown, the product or nail polish flows towards the opening 156 of the dip tube 154 while the propellant urges the nail polish through the dip tube 154 and through the valve assembly 152 when the valve assembly 152 is actuated by movement of stem 40. In one example embodiment, container 32 includes a funnel surface 158 which tapers towards the inlet 156 of the dip tube 154 so as to direct flow of the nail polish to the inlet 156. FIGS. 5 and 6 illustrate but two examples for the valve assembly and the dip tube configuration of container 32. Alternatively, other valve assembly and dip tube arrangements may be employed to allow the selective expulsion of the nail polish from container 32 such that nail polish is dispensed in the form of an aerosol. Although container 32 is illustrated as having a generally uniform cylindrical shape, container 32 may alternatively have various alternative configurations. Furthermore, in lieu of stem 40, container 32 may include other conventionally known or future developed mechanisms which would permit the release of nail polish from container 32.

Nozzle 34 is coupled to stem 40 of cylinder 32 and includes an outlet 42 through which the aerosol nail polish is sprayed. Nozzle 34 generally has a narrowing or conical interior such that nail polish sprayed through outlet 42 is in a fine spray to facilitate the creation of detailed designs. Although nozzle 42 is generally illustrated as having a fixed size outlet 42, nozzle 34 may alternatively have an outlet 42 that is adjustable in size. For example, nozzle 34 may alternatively be formed in multiple parts and operably coupled to a rotatable portion of housing 38, wherein the rotation of the portion of housing 38 enlarges or reduces the size of the outlet 42 to vary the spray characteristics of container 30. Examples of such adjustment mechanisms are found in conventionally known spray bottles.

Nozzle 34 is configured to dispense the nail polish along a dispensing axis 44 that is substantially parallel to or coextensive with the longitudinal axis 46 of container 32. As will be appreciated, during dispensing of the nail polish, nozzle 34 may be slightly bent or otherwise angularly displaced such that dispensing axis 44 is not exactly parallel or not exactly coextensive with axis 46.

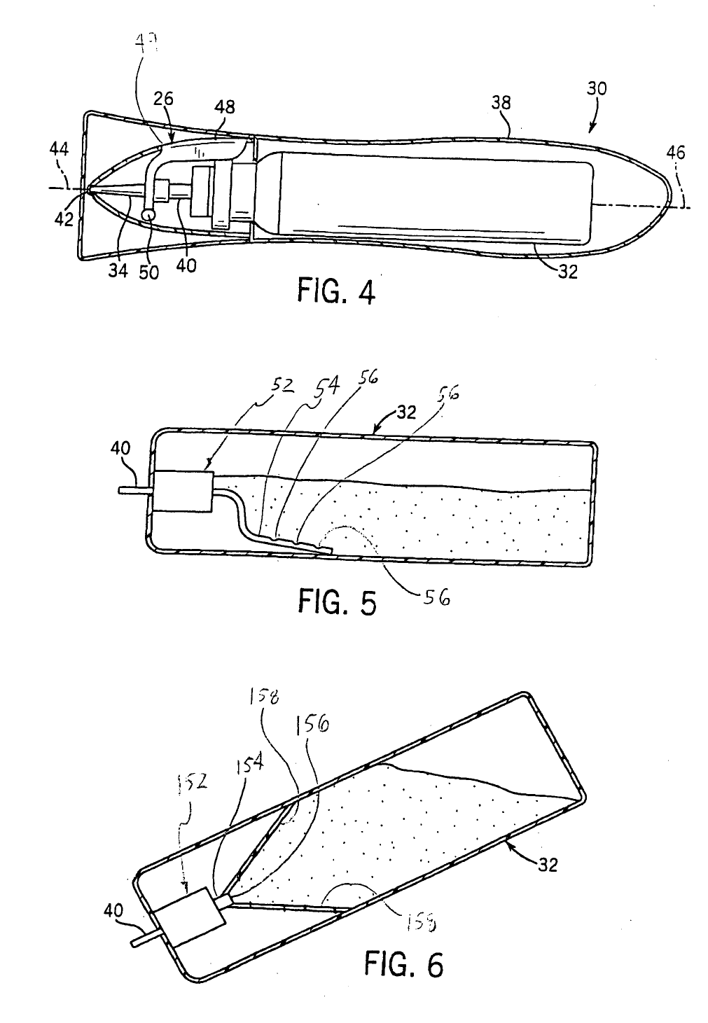

Actuator 36 is generally configured to selectively dispense the nail polish through nozzle 34. In the particular embodiment illustrated, actuator 36 includes a trigger 48, wherein movement of trigger 48 dispenses the nail polish through nozzle 34. Trigger 38 is preferably situated proximate to nozzle 34. In the particular embodiment illustrated, the surface of trigger 48 closest to outlet 42 at which movement of trigger 48 still causes the dispensation of nail polish is no greater than 1.0 inch from outlet 42 in a direction along axis 46. In the particular embodiment illustrated, this particular surface (as indicated by point 49 in FIG. 4) is approximately 0.75 inches from outlet 42. Trigger 48 is further disposed at least partially between container 32 and nozzle 34. As a result of the close proximity of trigger 48 to outlet 42, a user of applicator 30 may more closely position his or her fingers (including his or her trigger finger) to outlet 42, enabling greater control and precision when applying the nail polish to the nail.

In the particular embodiment illustrated, trigger 48 moves between a dispensing state and a non-dispensing state by pivoting about axis 50 in a clockwise direction as seen in FIG. 4. This pivotal movement of trigger 48 causes stem 40 to move. As a result, the pressurized nail polish within container 32 is released through stem 40 and sprayed through nozzle 42 generally along axis 44. The natural resilient nature of stem 40 and nozzle 34 return trigger 48 to the non-dispensing state once trigger 48 is released. In the particular embodiment illustrated, stem 40 and nozzle 34 are formed from a resilient polymer. Alternatively, applicator 36 may additionally include other means for resiliently biasing trigger 48 towards the non-dispensing state or position. Such means may include separate or integrally formed springs or resiliently compressible materials such as foam and the like.

Although trigger 48 is illustrated as pivoting between the dispensing state and the non-dispensing state by depressment of the surface of trigger 48 in a direction towards axis 46, actuator 36 may alternatively be configured such that trigger 48 linearly moves between the dispensing and the non-dispensing state. For example, actuator 36 may be configured such that trigger 48 slides in a direction along axis 46 between the states, wherein such movement causes a cam mechanism to be engaged so as to move stem 40. Similarly, actuator 36 may alternatively be configured such that trigger 48 is linearly depressed towards axis 46 wherein such depressment moves stem 40 to allow the dispensation of the nail polish. In alternative applications where container 32 includes other mechanisms besides stem 40 for expelling its contents, applicator 30 may likewise include alternatively configured actuators 36.

Housing 38 extends at least partially about container 32 and actuator 36 to provide applicator 30 with an ergonomic grip. In the particular embodiment illustrated, housing 30 completely surrounds container 32 and additionally surrounds nozzle 34 but for outlet 42. As best shown by FIG. 1, housing 38 is configured and is dimensioned such that applicator 30 may be gripped and manipulated in a fashion similar to that of a pen or marker. As a result, the outer surface of applicator 38 may be manipulated in a manner similar to that of a pen between the user's thumb, middle finger and index finger. This facilitates precision and control and enables more intricate and ornate designs to be created, especially by the at-home do-it-yourselfer.

As further shown by FIG. 1, housing 38 generally includes enlarged portion 54, middle portion 56 and nose 58. Enlarged portion 54 comprises a generally enlarged bulbous end portion of housing 38 opposite nose 58. Because portion 54 is enlarged, portion 54 makes contact with the user's fingers or other portions of the hand (depending upon the overall length of housing 38) to assist in maintaining the user's fingertips and thumb tip proximate to nose 58. Intermediate portion 56 extends between portion 54 and nose 58 and is generally more narrow as compared to portion 54. Portion 56 provides a constriction to which may easily be grasped by the user.

Nose 58 extends from intermediate portion 56 to opening 42. In the particular embodiment illustrated, nose 58 is frusto-conical shaped, terminating at outlet 42. Alternatively, nose 58 may taper to the point about outlet 42 in various other fashions. Because nose 58 tapers in size towards outlet 42, nose 58 does not interfere with the user seeing the precise point at which the nail polish is being applied to the nail.

As further shown by FIG. 1, nose 58 has an outer surface that is generally flush with the outer surface of trigger 48 when trigger 48 is in the non-dispensing position. As a result, the user may more comfortably grip and maintain a secure hold upon nose 58 while depressing or actuating trigger 48. Although less desirable, trigger 48 may alternatively extend above or partially below the surface of nose 58. Although not illustrated, trigger 48 may have serrations, dimples or other texture to prevent slippage. In a similar fashion, nose 58 may additionally include a textured surface such as dimples, grooves and the like, or may be provided with an outer exterior surface of compressible, preferably elastomeric material, such as a thermoplastic elastomer like Santoprene, sold by Advanced Elastomers. In lieu of being formed of a continuous, smooth outer surface, nose 58 may be composed of multiple pieces which are screwed or otherwise fastened to one another.

As shown by FIG. 1, applicator 30 additionally includes a cap 60 which receives nose 58 to cover outlet 42. Although cap 60 is illustrated as being pressed onto nose 58, cap 60 may alternatively be screwed or snapped onto nose 58. Although less desirable, cap 60 may be omitted.

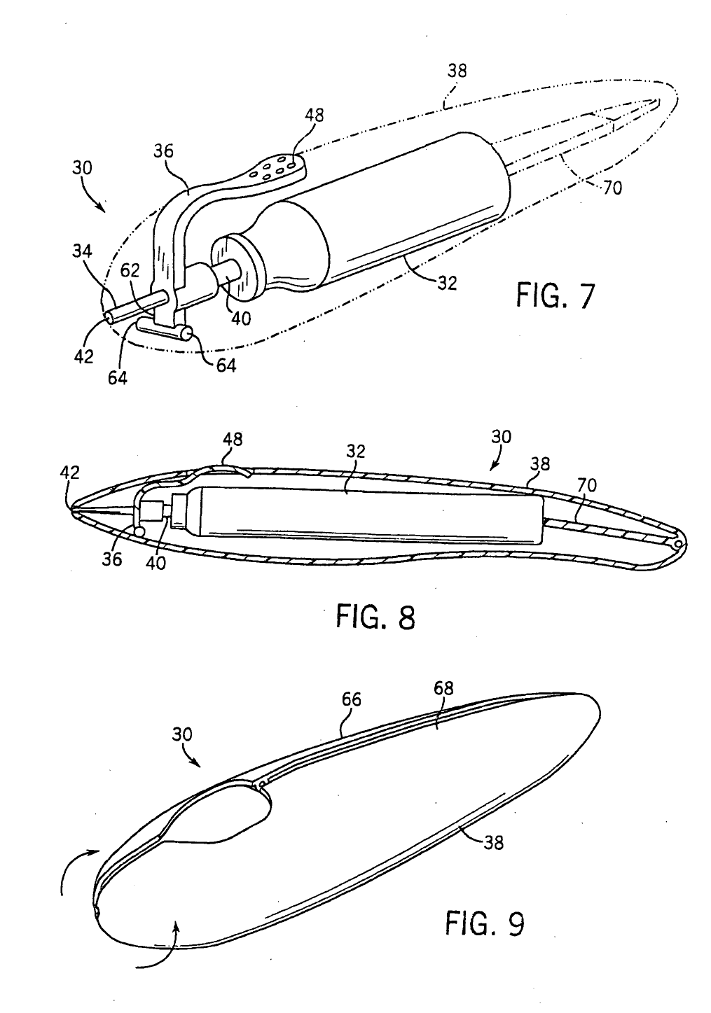

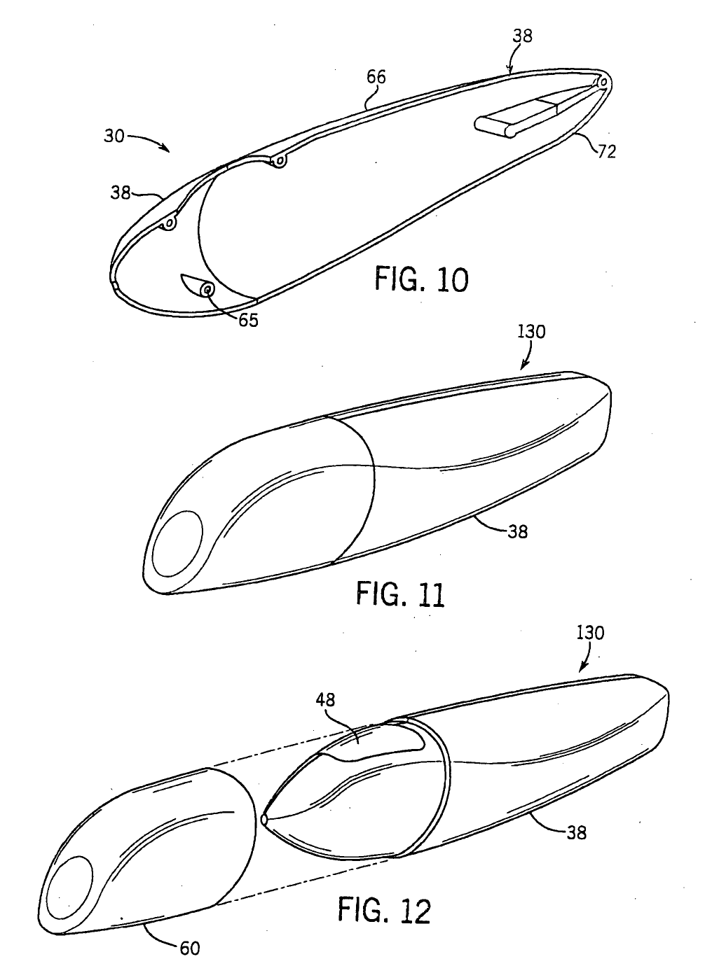

FIGS. 7-10 schematically illustrate applicator 30 in greater detail. As shown by FIG. 7, nozzle 34 and applicator 36 are preferably integrally formed as a single unitary body out of a resilient polymer. Nozzle 34 extends forwardly along axis 44 from stem 40 of container 32. Trigger 48 integrally extends from nozzle 34. As shown in FIG. 7, trigger 48 additionally includes a lower extension 62 having a pair of opposite axles 64 which are captured within opposing detents 65 (one of which is shown in FIG. 10) to pivotally support trigger 48. This integral construction simply provides manufacturing and assembly and reduces costs. Although less desirable, various other structures may be employed for pivotally supporting trigger 48.

As shown by FIGS. 8-10, housing 38 preferably comprises a shell extending about container 32, actuator 36 and nozzle 34. The shell is preferably provided by two halves 66, 68 which mate or mushroom together to surround the remaining components of applicator 30. To ensure proper positioning of container 32 within the shell formed by halves 66, 68, housing 38 additionally includes a stopping rib 70 which abuts a rear portion of container 32. Stopping rib 70 is preferably formed by two rib halves 72 provided on shell halves 66, 68. The aforementioned example construction of housing 38 enables applicator 30 to be easily manufactured and quickly assembled. Because housing 30 is generally hollow about container 32, applicator 30 is lightweight and therefore easier to manipulate and maneuver. In particular applications, shell halves 66 and 68 may be separated from one another by the user when container 32 is exhausted of its nail polish. As a result, the user may reuse housing 38 by replacing container 32. In addition, housing 38 may be opened to alternatively permit exchange of containers 32 containing different colored nail polish or a nail polish having different characteristics. In other applications, shell halves 66 and 68 are permanently joined to one another by glue, adhesive, welds or the like. In further alternative embodiments, body 38 may be molded or otherwise formed about container 32.

In still other applications, body 38 may be omitted leaving only container 32, nozzle 34 and actuator 36. In such alternative embodiments omitting housing 38, container 32 may itself be configured similar to the shape shown for housing 38. For example, container 32 may have an enlarged portion 54, an intermediate portion 56 and possibly a nose 58. Although less desirable, container 32 may alternatively have the general cylindrical shape shown in FIG. 4.

Overall, applicator 30 provides a nail polish application device that is simple, lightweight, easy and comfortable to grip, and easily manipulated with precision to create intricate and ornate patterns or designs upon fingernails or toenails. Applicator 30 does not have tubes connected to it which pose a risk of entanglement and which make manipulation difficult. Applicator 30 does not have a cup or other gravity feed mechanism which further makes grasping and manipulating the applicator difficult and limits the positions or orientations at which applicator 30 may be placed. Applicator 30 does not include large, bulky extensions or containers that extend perpendicular to the nozzle or the dispensing axis. In contrast, applicator 30 is configured such that applicator 30 may be gripped and manipulated in a fashion similar to that of a pen or marker, providing a comfortable, ergonomic tool that can be precisely manipulated. At the same time, applicator 30 is relatively simple and inexpensive, making it economical to purchase and use by at-home do-it-yourselfers.

FIGS. 11-12 illustrate applicator 130, an alternative embodiment of applicator 30 shown. Applicator 130 is substantially identical to applicator 30, except that applicator 130 has a slightly reconfigured housing 38. For ease of illustration, those elements of applicator 130 which correspond to applicator 30 are numbered similarly.

Although the present invention has been described with reference to example embodiments, workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. Because the technology of the present invention is relatively complex, not all changes in the technology are foreseeable. The present invention described with reference to the example embodiments and set forth in the above claims is manifestly intended to be as broad as possible. For example, unless specifically otherwise noted, the claims reciting a single particular element also encompass a plurality of such particular elements.

1. A nail polish applicator comprising:
a container extending along a longitudinal axis
a nail polish under pressure within the container;
a nozzle having an outlet opening through which the nail polish is expelled from the applicator; and
an actuator configured to selectively dispense the nail polish through the nozzle, wherein the nozzle has a longitudinal axis, wherein the outlet opening lies substantially along the longitudinal axis of the nozzle and is configured to substantially remain along the longitudinal axis of the container during reorientation of the container such that the orientation of the outlet opening substantially corresponds to the orientation of the container, the longitudinal axis of the nozzle being substantially parallel or coextensive with the longitudinal axis of container.

2. The applicator of claim 1, wherein the actuator includes a trigger movable in a direction towards the longitudinal axis of the container.

3. The applicator of claim 1, wherein the actuator includes a trigger proximate the nozzle.

4. The applicator of claim 1, wherein the applicator includes a housing at least partially about the container, wherein the housing extends at least a majority of the length of the container along the longitudinal axis.

5. The applicator of claim 4, wherein the housing includes a plurality of sections fastened together about the container.

6. The applicator of claim 4, wherein the housing supports the actuator.

7. The applicator of claim 4, wherein the actuator includes a trigger pivotally coupled to the housing about a pivot axis on a first side of the longitudinal axis of the nozzle, wherein the trigger has a depressment surface on a second opposite side of the longitudinal axis of the nozzle.

8. The applicator of claim 4, wherein the housing has a first outer exterior surface and wherein the actuator includes a trigger having a depressment surface substantially flush with the outer surface of the housing.

9. The applicator of claim 4, wherein the housing has a longitudinal length greater than the container and wherein the housing abuts and completely covers an axial end of the container opposite the nozzle, and wherein the container remains stationary inside the housing when actuated.

10. The applicator of claim 4, wherein the housing has a frusto-conical nose proximate the nozzle.

11. The applicator of claim 1 including a cap configured to removably cover the nozzle and wherein the comprises:
a first and configured to receive the nozzle; and
a second end that completely covers the outlet opening of the nozzle such that were nail polish to leak or otherwise eject from the outlet opening, the cap would contain the ejected nail polish.

12. The applicator of claim 1 wherein the actuator includes a trigger and wherein the applicator further include a cap configured to removably cover the trigger.

13. The applicator of claim 12, wherein the cap removably covers the nozzle, and wherein the comprises:
a first and configured to receive the nozzle; and
a second end that completely covers the outlet opening of the nozzle such that were nail polish to leak or otherwise elect from the outlet opening, the cap would contain the ejected nail polish.

14. The applicator of claim 4, wherein the housing tapers toward the opening.

15. The applicator of claim 1, wherein the container has an outer surface configured to be manipulated in a manner similar to that of a pen between a thumb, a middle finger, and an index finger, and wherein the index finger may engage the actuator when manipulating the outer surface in the pen-like manner.

16. The applicator of claim 1, wherein the container has a maximum outer diameter of 1.0 inch proximate the actuator.

17. The applicator of claim 1, wherein the actuator is disposed at least partially between the container and the nozzle.

18. The applicator of claim 1, wherein the actuator is no greater than 1.5 inches from the outlet in a direction along the longitudinal axis of the container.

19. The applicator of claim 1 including a propellant within the container.

20. The applicator of claim 1, wherein the propellant comprises a material distinct from the nail polish.

21. The applicator of claim 1, wherein the container has an interior side surface extending along the longitudinal axis of the container and wherein the applicator further includes a dip tube extending proximate to the side surface and having a plurality of openings.

22. The applicator of claim 1 including a valve assembly between the nozzle and the tube, wherein the valve assembly includes a stem and wherein the valve assembly actuates to an open state in response to movement of the stem.

23. The applicator of claim 22, wherein the valve assembly actuates to the open state in response to movement of the stem along the longitudinal axis of the container.

24. The applicator of claim 1 including a housing having a fist-conical portion about the nozzle.

25. The applicator of claim 24, wherein the actuator includes a trigger having a depressment surface along the frusto-conical portion.

26. The applicator of claim 1 including a housing at least partially about the container and extending along the longitudinal axis of the container, wherein the actuator includes a trigger having a depressment surface, the depressment surface not extending radially outwardly beyond the housing.

27. The applicator of claim 1, wherein the actuator has a forward most portion and wherein the nozzle extends forwardly beyond the forward most portion.

28. The applicator of claim 1 including a housing at least partially about the container, the housing extending along the longitudinal axis of the container and having a forwardly extending frusto-conical portion terminating at a tip, wherein the actuator has a forward most portion rearward of the tip.

29. The applicator of claim 1 including a housing completely enclosing the container and extending along a longitudinal axis of the container.

30. The applicator of claim 1 wherein the housing further comprises:
a first portion distant the nozzle configured to rest against the snuff box of a human hand; and
a second portion near the nozzle configured to be contacted by and between a middle finger of the human hand, wherein the housing and the actuator are further configured such that an index finger of the human hand may rest on and engage the actuator.

31. A nail polish applicator comprising:
a propellant container extending along a longitudinal axis;
a nail polish under pressure within the container;
a nozzle secured adjacent to the container and having an outlet;
an actuator configured to selectively dispense the nail polish through the nozzle, the actuator having a trigger circumferentially disposed along the longitudinal axis, wherein the nozzle is configured to dispense the nail polish along a dispensing axis substantially parallel or coextensive with the longitudinal axis of container; and
a housing at least partially about the container extending along the longitudinal axis of the container, wherein the housing has a frusto-conical nose proximate the nozzle.

32. The applicator of claim 31 wherein the housing further comprises:
a first portion distant the nozzle configured to rest against the snuffbox of a human hand; and
a second portion near the nozzle configured to be contacted by and between a middle finger of the human hand, wherein the housing and actuator are further configured such that an index finger of the human hand may rest on and engage the actuator.
